(19) United States
(12) Patent Application Publication
(10) Pub. No.: US 2013/0292970 A1
(43) Pub. Date: Nov. 7, 2013

(54) Trim Assembly with Air Duct and Handle

(71) Applicants: Robert E. Riedel, Durham (GB); Gregory J. Parsons, Peoria, IL (US); Kevin Urquhart, Birtley (GB)

(72) Inventors: Robert E. Riedel, Durham (GB); Gregory J. Parsons, Peoria, IL (US); Kevin Urquhart, Birtley (GB)

(73) Assignee: Caterpillar Inc., Peoria, IL (US)

(21) Appl. No.: 13/450,135

(22) Filed: May 7, 2012

(51) Int. Cl. B62D 33/06; B60R 13/02

(52) U.S. Cl. 296/190.09; 296/1.08; 296/190.08

(57) ABSTRACT

A trim assembly including a housing member, a complementary member, and a handle. The housing member and the complementary member cooperate to form a channel having an inlet that may be fluidly coupled to the outlet of a ventilation system of a machine. The channel provides airflow from the ventilation system to the interior of a cab of the machine by way of ventilation openings in the housing member. The handle is disposed toward the interior of the cab, the handle being adapted to be secured through at least the housing member to the frame.

### TECHNICAL FIELD

This patent disclosure relates generally to trim assemblies for machine cabs, and, more particularly to a trim assembly including an air duct and a handle.

### BACKGROUND

When used in rough terrain, heavy duty machines may experience strong swings or side to side movement that may be translated to the cab, and ultimately to the operator. This side to side movement may also result from the machine operating at high speeds that yield enhanced productivity. Unfortunately, the cab includes limited space for required controls and features. Any accommodations for addressing operator comfort and operator safety must also fit within this limited space, and must not encumber the operator's sightline or access to controls within the cab.

### SUMMARY

The disclosure describes, in one aspect, a trim assembly for a machine including a cab having an interior and being adapted to carry an operator. The machine further includes a ventilation system, and a frame. The frame at least partially defines the cab. The ventilation system has an outlet and is adapted to provide forced air to the outlet. The trim assembly includes a housing member, a complementary member, and a handle. The housing member has a front surface facing the interior of the cab, and a rear surface substantially opposite the front surface. The housing member defines a ventilation opening from the rear surface to the front surface. The complementary member is adapted to cooperate with the rear surface of the housing member, the complementary member and the housing member forming a channel therebetween. At least one of the complementary member and the housing member defines an inlet into the channel, the inlet being adapted to be fluidly coupled to the outlet to provide forced air from the ventilation system through the inlet, through the channel, and into the interior of the cab through the ventilation opening. The handle is disposed toward the interior of the cab, the handle being adapted to be secured through at least the housing member to the frame.

The disclosure describes, in another aspect, a trim assembly for a machine having a cab having an interior and being adapted to carry an operator. The machine further includes a ventilation system, and frame. The frame at least partially defines the cab. The ventilation system has an outlet and is adapted to provide forced air through the outlet. The trim assembly includes a housing member, a complementary member, a bracket, and a handle. The housing member has a front surface facing the interior of the cab, and a rear surface substantially opposite the front surface. The housing member defines a ventilation opening from the rear surface to the front surface. The complementary member secured to the rear surface of the housing member proximal the ventilation opening, the complementary member and the housing member forming a channel therebetween. At least one of the complementary member and the housing member define an inlet into the channel, the inlet being adapted to be fluidly coupled to the outlet to provide forced air from the ventilation system through the inlet, through the channel, and into the interior of the cab through the ventilation opening. The bracket has a flange disposed subjacent the rear surface, and is adapted to be secured to the frame. The handle is disposed toward the interior of the cab, and is secured to the flange through the housing member.

The disclosure describes, in yet another aspect, a mobile machine including a cab having an interior and being adapted to carry an operator, and a frame at least partially defining the cab. The machine further includes a ventilation system having an outlet, the ventilation system being adapted to provide forced air through the outlet. The machine also includes a trim assembly coupled to the frame. The trim assembly includes a housing member, a complementary member, a bracket, and a handle. The housing member has a front surface facing the interior of the cab, and a rear surface substantially opposite the front surface. The housing member defines a ventilation opening from the rear surface to the front surface. The complementary member is in cooperation with the rear surface of the housing member, the complementary member and the housing member forming a channel therebetween. At least one of the complementary member and the housing member define an inlet into the channel, the inlet being fluidly coupled to the outlet to provide airflow from the ventilation system through the inlet, through the channel, and into the interior of the cab through the ventilation opening. The bracket has a flange disposed subjacent the rear surface, the bracket being secured to the frame. The handle is disposed toward the interior of the cab, the handle being secured to the flange through the housing member.

### BRIEF DESCRIPTION OF THE DRAWING(S)

FIG. 1 is a machine constructed in accordance with teachings of the disclosure.

FIG. 2 is a fragmentary isometric view of an interior of a cab of a machine constructed in accordance with teaching of the disclosure.

FIG. 3 is a fragmentary cross sectional view of a bracket and the handle of the view of FIG. 1.

FIG. 4 is an isometric view of a front surface of a housing member of the trim assembly.

FIG. 5 is an isometric view of a rear surface of the housing member of the trim assembly, and the complementary member.

### DETAILED DESCRIPTION

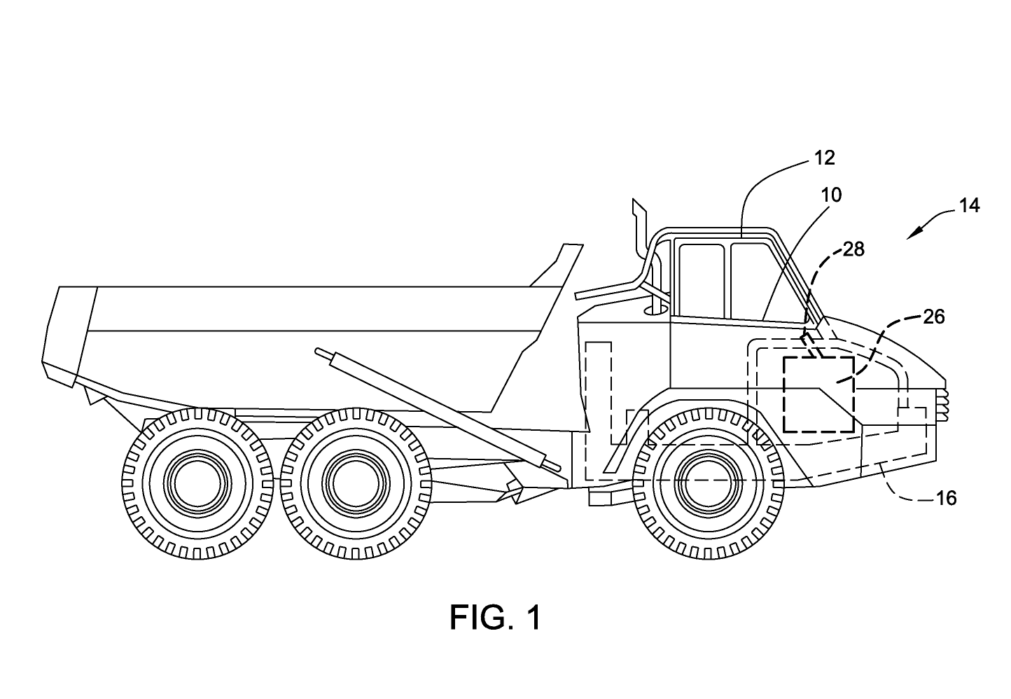

This disclosure relates to a trim assembly 10 for a cab 12 of a machine 14, a mobile example of which is shown in FIG. 1. The arrangement has universal applicability with various types of machines 14, such as such, by way of example only, motor graders, front end loaders, heavy duty trucks, or articulated trucks, such as the articulated truck illustrated. The arrangement may be particularly applicable in machines that may be utilized in rough applications or that may have sustained or intermittent jarring to the cab 12. The term “machine” may refer to any machine that performs some type of operation associated with an industry such as mining, construction, farming, transportation, or any other industry known in the art. Moreover, one or more implements may be connected to the machine 14. Such implements may be utilized for a variety of tasks, including, for example, brushing, compacting, grading, lifting, loading, plowing, ripping, and include, for example, augers, blades, breakers/hammers, brushes, buckets, compactors, cutters, forked lifting devices, grader bits and end bits, grapples, blades, rippers, scarifiers, shears, snow plows, snow wings, and others.

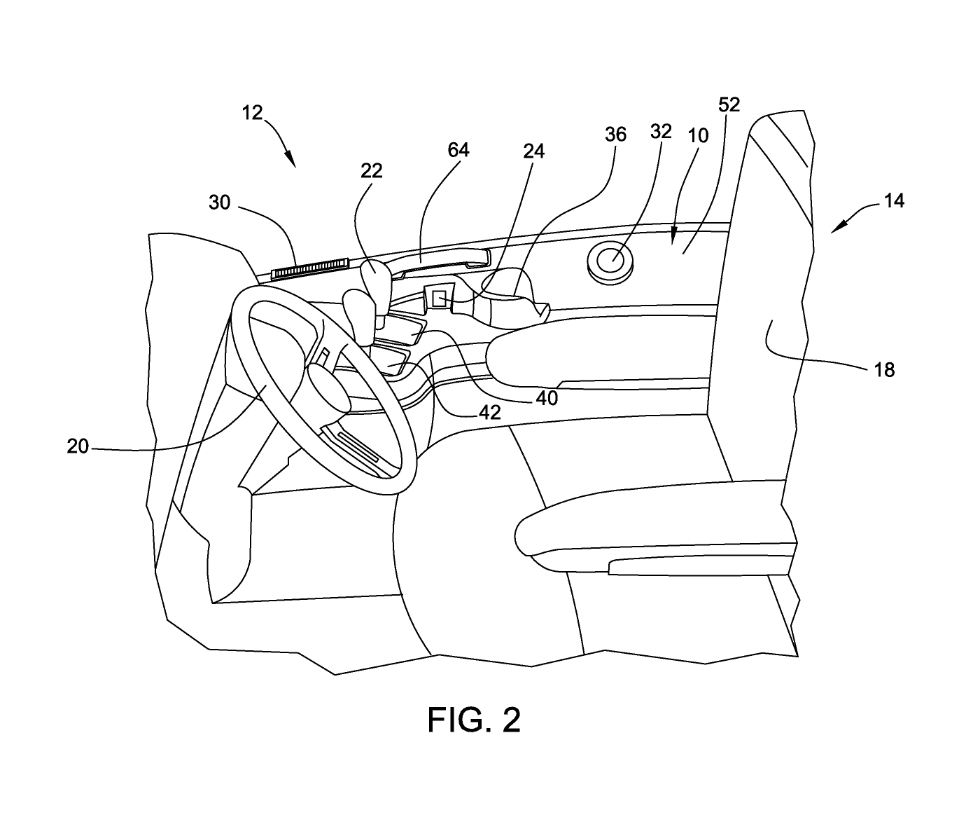

The machine 14 may include a frame 16, a portion of which is disposed in the region of the cab 12. It will be noted that the frame 16 at least partially defines the structure of the cab 12, here, a side wall of the cab 12. As shown in FIG. 2, the cab 12 may include a seat 18 for carrying an operator, as well as controls such as, for example, a steering wheel 20, one or more levers or gear shifts 22, a joy stick (not shown), one or more actuators 24, such as may be used for the operation of locks or windows, or one or more speakers (not shown).

The machine 14 includes a ventilation system (illustrated schematically as 26 in FIG. 1), that may be a so-called HVAC system, or heating, ventilation, and air conditioning system. The ventilation system 26 includes a plurality of ducts, and at least one outlet 28 in fluid communication with one or more ventilation openings 30, 32 into the cab 12. In this way, forced air is provided from the ventilation system 26 through the outlet 28 and on to the ventilation openings 30, 32 into the cab 12.

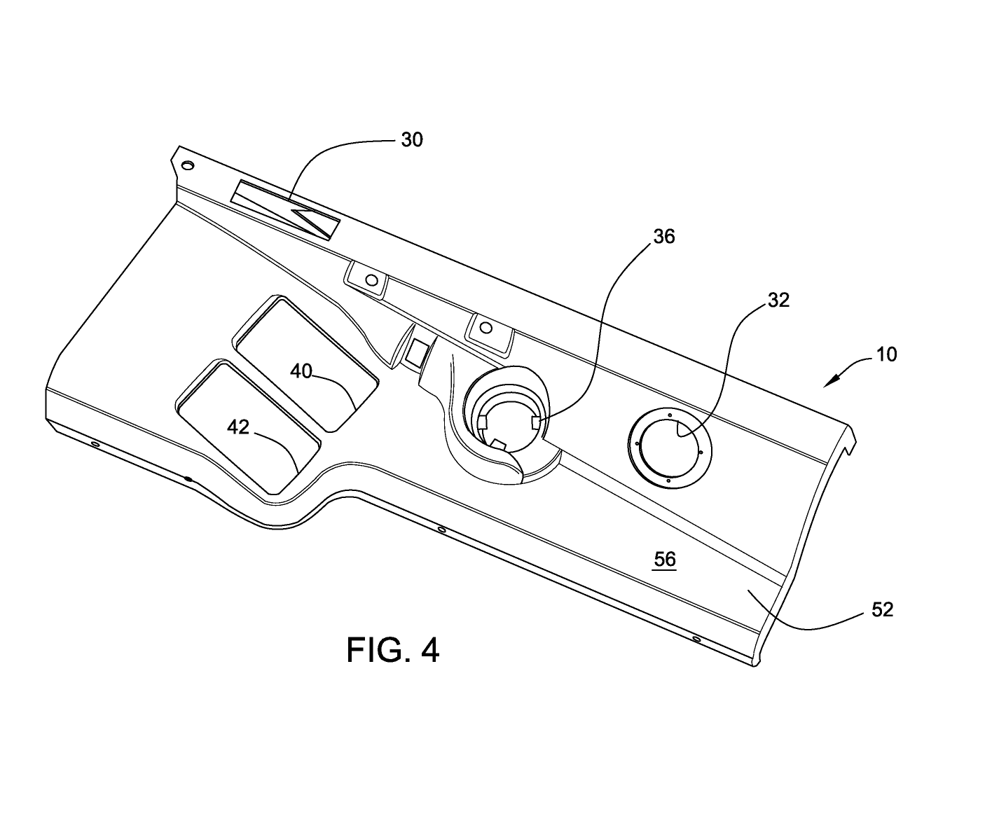

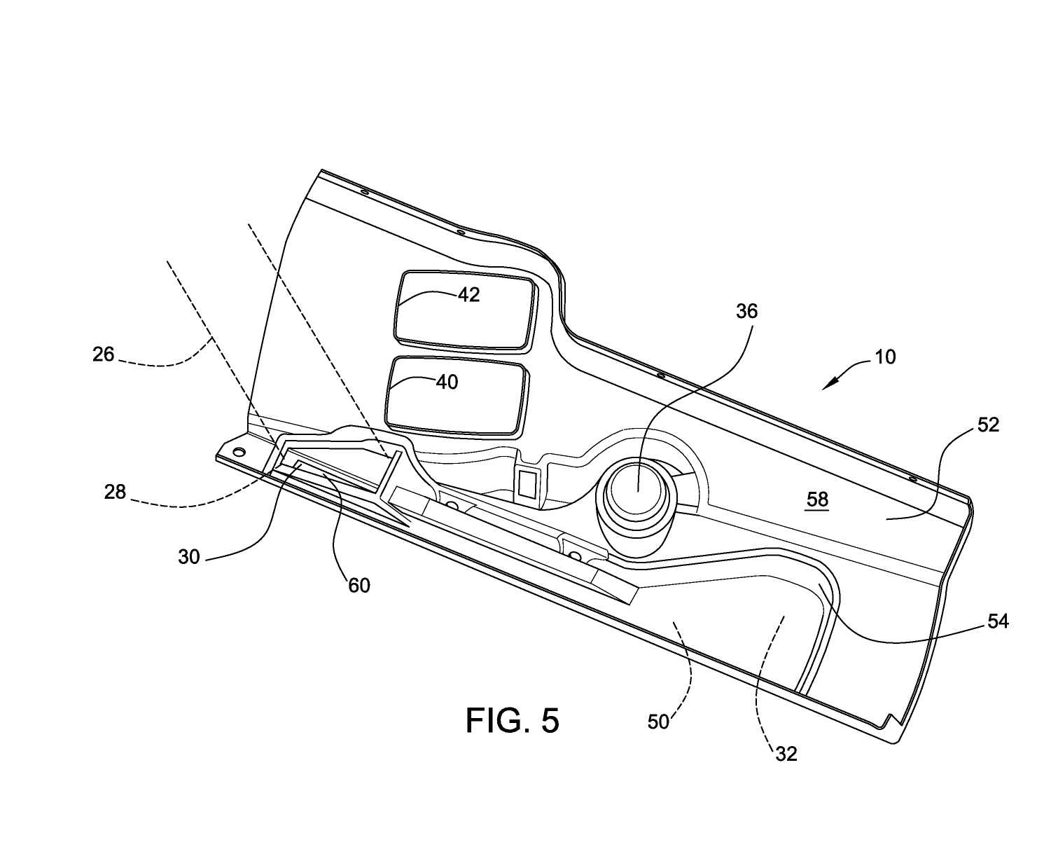

In order to present a finished appearance to the cab 12, the trim assembly 10 is provided along a portion of the cab 12. The trim assembly 10 is shown in greater detail in FIGS. 4 and 5. The trim assembly 10 may include amenities such as a recess in the form of cup holder 36, for example. Further, the trim assembly 10 may include one or more openings 40, 42 through which features such as the one or more levers or gear shifts 22, joy stick (not shown), actuator 24, or one or more speakers (not shown) may be exposed or extend.

According to a feature of this disclosure, the trim assembly 10 includes a channel 50 that provides fluid communication for airflow from the ventilation system 26 to one or more ventilation openings 30, 32. More specifically, the trim assembly 10 includes a housing member 52 and a complementary member 54 that cooperate to form the channel 50. The housing member 52 has a front surface 56 that faces the interior of the cab 12, and a rear surface 58 substantially opposite the front surface 56. As may be seen in FIGS. 4 and 5, the housing member defines the ventilation openings 30, 32 from the rear surface to the front surface in the illustrated embodiment.

The complementary member 54 is visible in the bottom view of the trim assembly 10 shown in FIG. 5. The complementary member 54 cooperates with the rear surface 58 of the housing member 52 such that the complementary member 54 and the housing member 52 form the channel 50 therebetween. The complementary member 54 may be coupled to the housing member 52 by any appropriate method. By way of example only, the complementary member 54 may be ultrasonically welded, adhered, bolted, or riveted to the housing member 52, or any combination of these or any other appropriate methods may be utilized.

As may also be seen in FIG. 5, the complementary member 54 includes an inlet 60 into the channel 50. The ventilation openings 30, 32 of the housing member 52 open into the channel 50 so that air flowing into the channel 50 through the inlet 60 into the channel 50 is directed out of the channel 50 through the ventilation openings 30, 32 into the cab 12. While in the illustrated embodiment, the inlet 60 into the channel 50 is formed entirely by the complementary member 54, the inlet could alternately be formed by a combination of the housing member 52 and the complementary member 54, or by the housing member 52 alone. When the trim assembly 10 is installed in the machine 14, the inlet 60 is fluidly connected to the outlet 28 of the ventilation system 26 so that forced air provided from the ventilation system 26 flows from the outlet 28, through the inlet 60, through the channel 50, and into the interior of the cab 12 through the ventilation openings 30, 32.

According to another feature of the disclosure, the trim assembly 10 includes a handle 64 disposed within the interior of the cab 12 so that an operator (not shown) may readily grasp the handle 64 during rough operations of the machine 14. In order to securely mount the handle 64 within the cab 12, a bracket 66 is provided subjacent the housing member 52. The handle 64 is secured to the bracket 66 by any appropriate arrangement. In the illustrated embodiment, the handle 64 is bolted to the bracket 66 by rivets, bolts 68, or the like, the bracket 66 being disposed subjacent the housing member 52 such that the housing member 52 is sandwiched between the handle 64 and the bracket 66. The housing member 52 may be molded separately from the bracket 66, the parts being assembled post molding as illustrated, or the bracket 66 may be molded into the housing member 52 or the complementary member 54. When the trim assembly 10 is mounted within the cab 12, the bracket 66 is likewise secured to the frame 16 of the machine 14.

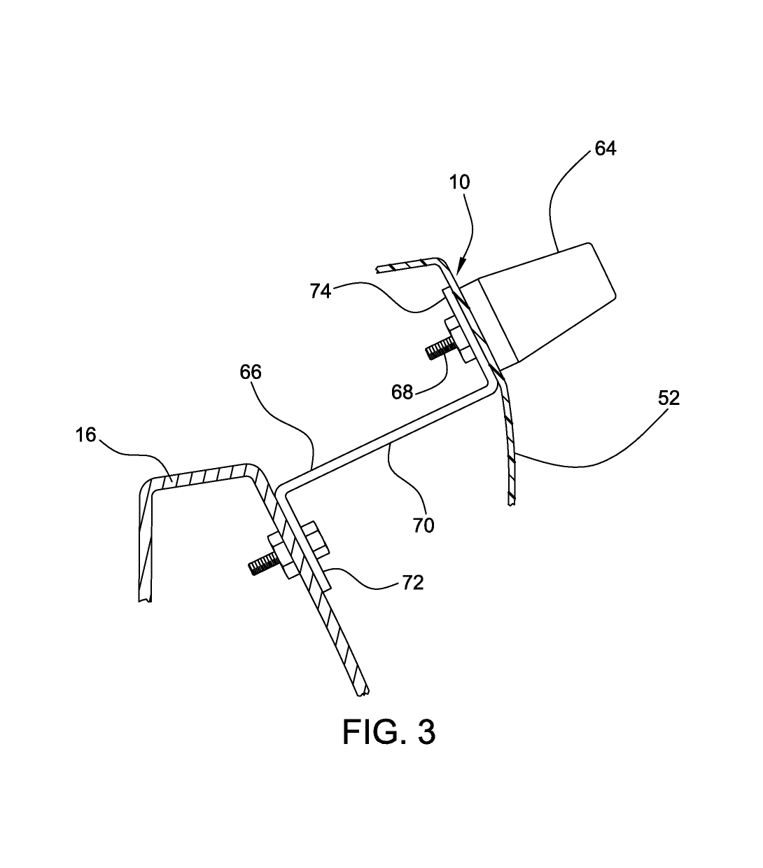

The bracket 66 may be of any appropriate design. As may be seen in FIG. 3, for example, a Z-shape may be particularly appropriate, allowing the bracket 66 and handle 64 to be mounted with a minimum of obstruction or interference within the cab 12. In this regard, the bracket may include a web 70 having flanges 72, 74 extending in opposite directions from either end of the web 70. In this way, one of the flanges 72 is mounted to the frame 16, while the handle 64 is mounted to the other of the flanges 74. While the flanges 72, 74 are substantially parallel and extending normal to the web 70 in the illustrated embodiment, the flanges 72, 74 may be alternately disposed, depending upon the environment in which the bracket 66 is mounted and the space constraints.

### Industrial Applicability

The present disclosure is applicable to machines 14 that may exhibit side to side movements during working operation or other movement of the machine 14.

The disclosed arrangement may enhance operator comfort and/or safety by providing a grab handle 64 within the cab 12 for easy access by the operator.

The disclosed arrangement may additionally provide added comfort to the operator by minimizing the space occupied by ducting and equipment required to facilitate airflow from a ventilation system 26 into the interior of the cab 12.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A trim assembly for a machine including a cab having an interior and being adapted to carry an operator, a ventilation system, and frame, the frame at least partially defining the cab, the ventilation system having an outlet and being adapted to provide forced air to the outlet, the trim assembly comprising:
a housing member having a front surface facing the interior of the cab, and a rear surface substantially opposite the front surface, the housing member defining a ventilation opening from the rear surface to the front surface,
a complementary member adapted to cooperate with the rear surface of the housing member, the complementary member and the housing member forming a channel therebetween, at least one of the complementary member and the housing member defining an inlet into the channel, the inlet being adapted to be fluidly coupled to the outlet to provide forced air from the ventilation system through the inlet, through the channel, and into the interior of the cab through the ventilation opening, and
a handle disposed toward the interior of the cab, the handle being adapted to be secured through at least the housing member to the frame.

2. The trim assembly of claim 1 further including a bracket, the bracket being adapted to be secured to the frame, and the handle being adapted to be secured to the bracket.

3. The trim assembly of claim 2 wherein the bracket is disposed at least partially subjacent the housing member.

4. The trim assembly of claim 2 wherein the bracket is of a Z-shape, the bracket including a web, a first flange extending in a first direction from a first end of the web, and a second flange extending in a second direction from a second end of the web, wherein the handle is secured to the first flange and the second flange is adapted to be secured to the frame.

5. The trim assembly of claim 4 wherein the first flange and the second flange are configured to be substantially parallel and extend in opposite directions from the web.

6. The trim assembly of claim 4 wherein the first flange is disposed substantially normal to the web.

7. The trim assembly of claim 1 wherein the housing member includes at least one opening between the rear and front surfaces, the opening sized and adapted to accommodate the passage at least one control.

8. The trim assembly of claim 6 wherein the opening is sized and adapted to accommodate the passage of at least one of a gearshift assembly, a joy stick assembly, a lock actuator assembly, or a speaker assembly.

9. The trim assembly of claim 4 wherein the first flange is disposed at least partially subjacent the housing member, and wherein the housing member includes at least one opening between the rear and front surfaces, the opening sized and adapted to accommodate the passage at least one of a gearshift assembly, a joy stick assembly, a lock actuator assembly, or a speaker assembly.

10. The trim assembly of claim 9 wherein the first flange is disposed adjacent to the rear surface of the housing member.

11. The trim assembly of claim 1 adapted to be disposed along a side portion of the cab.

12. A trim assembly for a machine having a cab having an interior and being adapted to carry an operator, a ventilation system, and frame, the frame at least partially defining the cab, the ventilation system having an outlet and being adapted to provide forced air through the outlet, the trim assembly comprising:
a housing member having a front surface facing the interior of the cab, and a rear surface substantially opposite the front surface, the housing member defining a ventilation opening from the rear surface to the front surface,
a complementary member secured to the rear surface of the housing member proximal the ventilation opening, the complementary member and the housing member forming a channel therebetween, at least one of the complementary member and the housing member defining an inlet into the channel, the inlet being adapted to be fluidly coupled to the outlet to provide forced air from the ventilation system through the inlet, through the channel, and into the interior of the cab through the ventilation opening,
a bracket having a flange disposed subjacent the rear surface, the bracket being adapted to be secured to the frame, and
a handle disposed toward the interior of the cab, the handle being secured to the flange through the housing member.

13. The trim assembly of claim 12 wherein the bracket is of a Z-shape, the bracket further including a web, the flange extending in a first direction from a first end of the web, and a second flange extending in a second direction from a second end of the web, wherein the second flange is adapted to be secured to the frame.

14. The trim assembly of claim 12 wherein the housing member includes at least one opening between the rear and front surfaces, the opening sized and adapted to accommodate the passage at least one control.

15. The trim assembly of claim 14 wherein the opening is sized and adapted to accommodate the passage of at least one of a gearshift assembly, a joy stick assembly, a lock actuator assembly, or a speaker assembly.

16. The trim assembly of claim 12 adapted to be disposed along a side portion of the cab.

17. A mobile machine comprising
a cab having an interior and being adapted to carry an operator,
a frame at least partially defining the cab,
a ventilation system having an outlet, the ventilation system being adapted to provide forced air through the outlet,
a trim assembly coupled to the frame, the trim assembly including
a housing member having a front surface facing the interior of the cab, and a rear surface substantially opposite the front surface, the housing member defining a ventilation opening from the rear surface to the front surface,
a complementary member in cooperation with the rear surface of the housing member, the complementary member and the housing member forming a channel therebetween, at least one of the complementary member and the housing member defining an inlet into the channel, the inlet being fluidly coupled to the outlet to provide airflow from the ventilation system through the inlet, through the channel, and into the interior of the cab through the ventilation opening,
a bracket having a flange disposed subjacent the rear surface, the bracket being secured to the frame, and
a handle disposed toward the interior of the cab, the handle being secured to the flange through the housing member.

18. The machine of claim 17 wherein the bracket is of a Z-shape.

19. The machine of claim 17 wherein the housing member defines at least one of a recess along the front surface, the recess being sized to accommodate a cup, or at least one opening between the rear and front surfaces, the opening sized and adapted to accommodate the passage at least one control.

20. The machine of claim 17 wherein the trim assembly is disposed along a side portion of the cab.
